(19) United States
(12) Patent Application Publication
(10) Pub. No.: US 2009/0058148 A1
(43) Pub. Date: Mar. 5, 2009

(54) Truck roof rear edge protector

(76) Inventor: William Garrity, Lusby, MD (US)

Correspondence Address: JAMES RAY & ASSOCIATES, 2640 PITCAIRN ROAD, MONROEVILLE, PA, 15146, US

(21) Appl. No.: 12/229,949

(22) Filed: Aug. 28, 2008

Related U.S. Application Data
(60) Provisional application No. 60/966,922, filed on Aug. 30, 2007.

(51) Int. Cl. B60J 10/12

(52) U.S. Cl. 296/216.09

(57) ABSTRACT

A rear edge truck roof protector consists of an elongated substantially rigid strip of a preselected material having a predetermined length and a longitudinal arcuate edge, the arcuate edge being convex on the topside, and the rigid strip has one or more fasteners for attaching the elongated rigid strip either permanently or removably to a truck rear roof edge. Also included is a notch or a cut-out area having a predetermined configuration near the midpoint of the arcuate edge to ensure that the third brake light is not obstructed.

### CROSS REFERENCE TO RELATED APPLICATION

This patent application is related to and claims priority from U.S. Provisional Patent Application Ser. No. 60/966,922 filed Aug. 30, 2007.

### FIELD OF THE INVENTION

The present invention relates, in general, to pick up truck cargo devices and, more particularly, this invention relates to truck cab protection from long loads.

### BACKGROUND OF THE INVENTION

Prior to the conception and development of the present invention, pick-up truck owners have devised or purchased numerous ways to carry cargo or tools longer than the bed so as not to touch or damage the roof. A rack built into the bed is one of the most common, but these detract from the appearance, add a considerable cost, and make it difficult to cover the bed.

U.S. Pat. No. 4,984,837 discloses a permanently mounted load support assembly that extends above the rear edge of a pick up truck cab. The construction is complicated by the pivoting nature of the top surface and fold-down end flaps.

Moore in U.S. Pat. No. 6,454,149 describes a device and method for protecting a truck cab roof while carry long objects in the bed. The plastic or elastomeric protector has limited width. Karp in U.S. Pat. No. 4,957,400 discloses pick-up truck load pads for the cab and tailgate. The cab protector of Karp is elastomeric foam with temporary installation means, mainly straps that attach with clips to the rain gutters, which are not common on vehicles in recent years.

### SUMMARY OF THE INVENTION

The present invention provides a rear edge truck roof protector including an elongated substantially rigid strip of a preselected material having a predetermined length and a longitudinal arcuate edge, the arcuate edge being convex on the topside, and having an attachment means for fastening the elongated rigid strip either permanently or removably to a truck rear roof edge. Also included is a notch or a cut-out area having a predetermined configuration near the midpoint of the arcuate edge to ensure that the third brake light is not obscured. The protector can be either metal or plastic, but diamond plate aluminum is preferred.

### OBJECTS OF THE INVENTION

It is, therefore, one of the primary objects of the present invention to provide an economical yet effective protective guard for the rear edge of a cab roof on trucks, particularly pick-up trucks.

Another object of the present invention is to provide a roof rear edge protector that maintains a low profile to minimize wind resistance and noise.

Still another object of the present invention is to provide a rear roof edge protector that enables carrying long loads such as ladders without damaging the roof.

Yet another object of the present invention is to provide a durable rear edge roof protector that can be either removable or permanently installed.

An additional object of the present invention is to provide a pick-up truck roof rear edge protector which does not cover the third brake light on most trucks.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a perspective view of the present invention as it may be applied on a pick up truck.

FIG. 2 presents a perspective view of the present invention in use.

FIG. 3 is an exploded perspective view of a removable embodiment of the present invention.

FIG. 4 is a cross sectional view of a second removable embodiment of the present invention.

FIG. 5 is a cross sectional view of a third removable embodiment of the present invention.

FIG. 6 is a cross sectional view illustrating a second permanent attachment method of the present invention.

### DETAILED DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

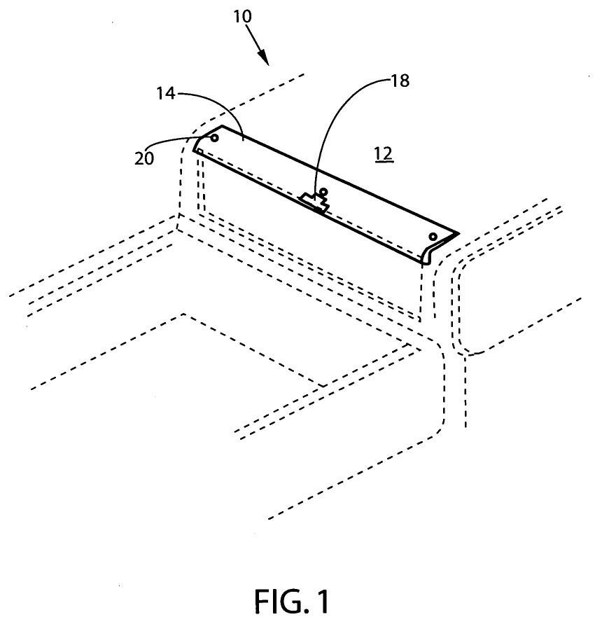

Referring initially to FIG. 1, the present invention 10 is shown in perspective relative to the dotted outline of a pick-up truck to show where it would be mounted on a truck cab 12. The elongated protector 14 would extend nearly the entire width of the cab and have an L-shaped cross section to conform to the contour of the rear edge of the truck cab 12. An added feature for most trucks would be a cut-out section 18 near the center of the curved rear edge to permit visibility of the third brake light. This section 18 could be a rectangular notch or an emblem of some sort, such as an automotive one. In a permanent mode of installation, bolts or screws 20 are used to hold the protector 14 in place, and sealant is used around the screws or bolts. For those wanting to avoid putting holes in the cab, double sided foam tape or glue could be used along the underside of the protector 14 to provide a permanent type of installation. Alternatively, the strip 14 is put in position only as needed and held in place by a removable means.

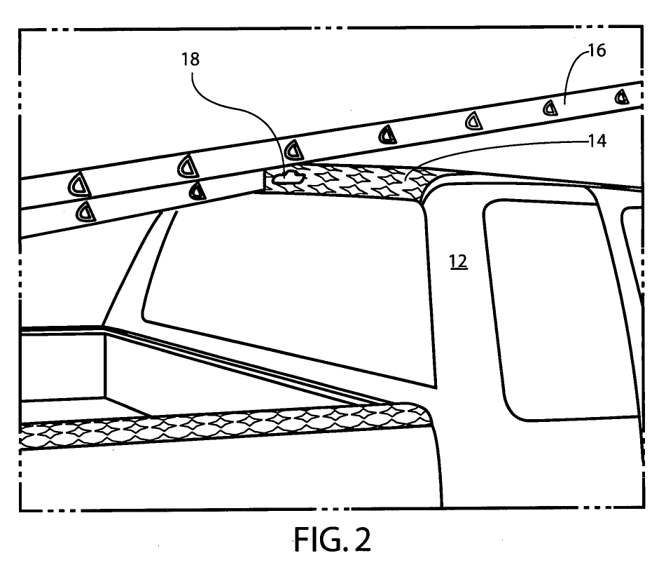

FIG. 2 illustrates the use of the present invention on a truck cab 12 in conjunction with a load 16. The rear curved lip of the protector extends down to approximately the rear cab window, and has a cut-out section 18 to maintain visibility of the third brake light. The protector can be held in place temporarily by the load 16, or by adhesive-backed magnetic tape on the underside of the protector 14. Alternatively, the protector can be held on substantially permanently by screws, bolts, adhesive, or double-sided tape. The protector strip 14 can be made from metal or plastic, but preferably is constructed of diamond plate aluminum.

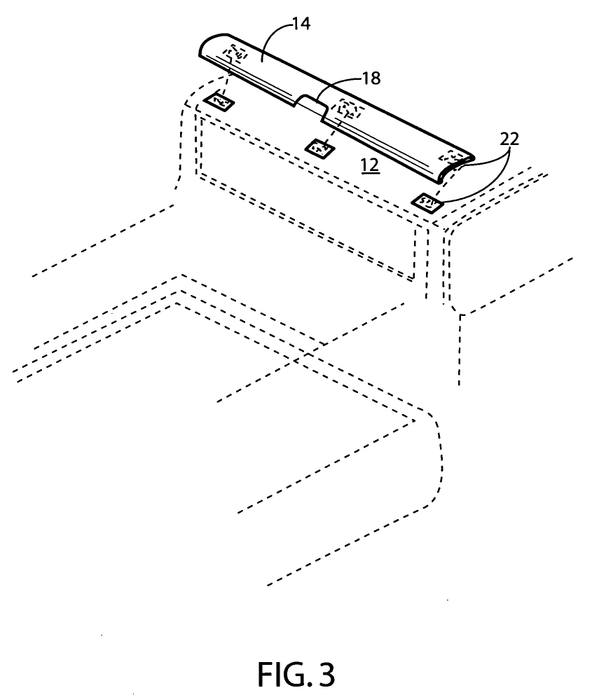

FIG. 3 provides an exploded perspective view of a first removable embodiment of the present invention. The protective strip 14 has adhesive-backed hook and loops patches 22 (Velcro®) on the underside which mate with patches adhered to the rear roof edge of the scab 12.

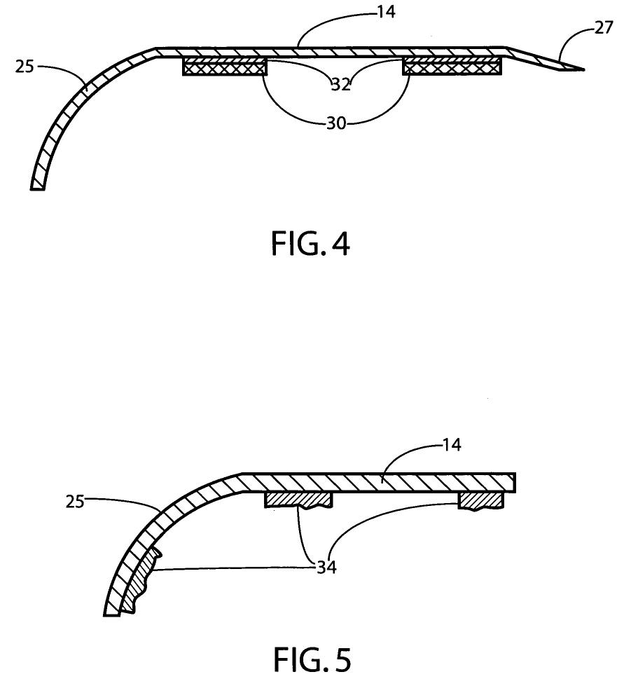

FIG. 4 provides a cross sectional view of the present invention in a second removable embodiment. The protective member 14 has on the underside magnetic strips or patches 30 held to the underside of protector 14 by an adhesive layer 32. The arcuate rear edge 25 and a beveled front edge 27 are also shown. When placed on the cab roof with the arcuate edge 25 along the rear edge of the cab, the magnets will contact the metal cab roof and hold it in place.

FIG. 5 is a sectional view of a third removable embodiment of the present invention. Protector strip 14 has felt, rubber, or foam strips or pads 34 along much of the underside of the protector 14. In this variation, the protector is placed along the cab roof edge only as needed, and held in place by friction from the combination of the tied down load and the soft strips or pads 14. When a load is not being carried, it is stored somewhere in the truck or elsewhere.

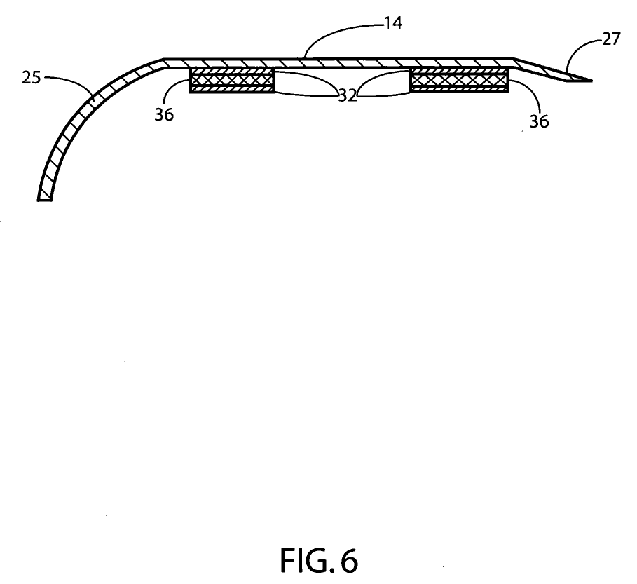

FIG. 6 provides a cross sectional view of the present invention in a second permanent embodiment. The protective member 14 has on the underside double-sided tape strips or patches typically consisting of a foam core 36 held to the underside of protector 14 and the cab roof by adhesive layers 32. The arcuate rear edge 25 and a beveled front edge 27 are also shown. When placed on the cab roof with the arcuate edge 25 along the rear edge of the cab, the lower adhesive layer 32 of foam-tape sections will contact the metal cab roof and hold it in place.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

What is claimed is:

1. A rear edge truck roof protector comprising:
a) an elongated substantially rigid strip of a preselected material having a predetermined length defining a topside and an underside with an arcuate longitudinal edge, said arcuate edge being convex on said topside;
b) an attachment means for fastening said elongated rigid strip one of permanently and removably to a truck rear roof edge; and
c) one of a notch and a cut-out area having a predetermined configuration disposed substantially centrally in said arcuate edge.

2. The rear edge truck roof protector, according to claim 1, wherein said predetermined length is between about four and six feet.

3. The rear edge truck roof protector, according to claim 1, wherein said attachment means for permanent fastening is one of screws, bolts, double-sided tape, and adhesive.

4. The rear edge truck roof protector, according to claim 1, wherein said attachment means for removable fastening is one of magnets, frictional force, and hook and loop strips.

5. The rear edge truck roof protector, according to claim 1, wherein said preselected material is one of metal and plastic.

6. The rear edge truck roof protector, according to claim 5, wherein said metal is diamond plate aluminum.

7. The rear edge truck roof protector, according to claim 1, wherein said preselected configuration is generally rectangular.

8. The rear edge truck roof protector, according to claim 1, wherein said preselected configuration is an automotive emblem.
